(19) United States
(12) Patent Application Publication
(10) Pub. No.: US 2005/0043419 A1
(43) Pub. Date: Feb. 24, 2005

(54) Method for producing foamed products based on aromatic polyester resin with low melting point

(75) Inventors: Yeon-Soo Kim, Gumi City (KR); Deog-Jae Jo, Gumi City (KR); Tae-Kyung Kim, Seoul City (KR)

Correspondence Address: NIXON & VANDERHYE, PC, 1100 N GLEBE ROAD, 8TH FLOOR, ARLINGTON, VA, 22201-4714, US

(73) Assignee: SAEHN INDUSTRIES INCORPORATION, Kyungbuk (KR)

(21) Appl. No.: 10/751,454

(22) Filed: Jan. 6, 2004

(30) Foreign Application Priority Data
Aug. 18, 2003 (KR) 10-2003-0056892

(51) Int. Cl. C08J 9/00

(52) U.S. Cl. 521/79

(57) ABSTRACT

The present invention concerns a method for producing a foamed product based on aromatic polyester resin, wherein at least one of IPA, DEG, TEG and PEG is selected and copolymerized at the step of aromatic polyester polymerization to produce aromatic polyester resin with a low melting point whose melting point ranges 80 to 180□. The resin is then cross-linked by means of an organic peroxide cross-link agent, subject to melt mixing at a temperature ranging 80 to 180□ and then foamed in order to produce a foamed product based on aromatic polyester resin of a low melting point, excellent in thermal resistance, foaming magnification, strength, etc. The aromatic polyester resin represented by polyethyleneterephthalate is known excellent in chemical properties such as chemical resistance, solvent resistance, weather resistance, etc., and physical properties such as thermal resistance, dimension stability, rigidity, gas barrier capability, etc., and thus widely used for packaging electric/electronic parts, films, bottle containers and the like.

### BACKGROUND OF THE INVENTION

1. Technical Field

The present invention relates to a method for producing a foamed product based on aromatic polyester resin, and, more particularly, to a method for producing a foamed product, using aromatic polyethyleneterephthalate (PET).

2. Description of the Prior Art

The polystyrene resin conventionally used as a packaging material may produce styrene dimer or styrene trimer at high temperature. Such styrene dimer or styrene trimer is suspected to be an environmental hormone, that is a material causing cryptorrhea, by Korean and overseas scholars and researchers. At present only about 50% of the polystyrene is recycled, resulting in environmental pollution. Scholars and researchers in the relevant industry have studied production of foamed products based on polyethyleneterephthalate which can be recycled well without worries about environmental hormones because of the aforementioned problems of the foamed products using the polystyrene resin.

The aromatic polyester resin represented by the polyethyleneterephthalate is evaluated to have chemical properties of chemical resistance, solvent resistance, weather resistance, etc., and also to exhibit excellent physical properties such as thermal resistance, dimensional stability, rigidity, gas barrier capability, etc. Therefore, it is widely used as a packaging material for electric and electronic parts, films, bottle containers, etc.

As a reference, the polyester resin also includes biodegradable aliphatic polyester {e.g., PCL (polycaprolacton), PLA (polylactic acid), PES (polyethylene succinate), PBS (polybutylene succinate), etc.} resin lately emerging, in addition to the aromatic polyester resin. However, it is difficult to produce molded products with such polymers because the molecular parts by weight of the polymers cannot be raised by more than a given amount at the time of polymerization (due to low melting strength thereof). It is also very difficult to commercialize the products due to such weak physical properties as thermal resistance, tear strength, etc. when the polymers are foamed and molded to produce materials for packaging articles. Accordingly, the aromatic polyester resin is still preferred for producing foamed products for packaging articles.

The aromatic polyester resin has aforementioned various advantages as a raw material for producing materials for packaging articles, but exhibits bad melt resin flow in the manufacturing process due to its high melt index MI in producing foamed products by means of extrusion foaming or injection foaming. Since the melt resin cannot block outflow of foaming gas, it is also impossible to produce good foamed products based on the aromatic polyester resin.

In relation to the above technology, the open Japan Patent publication No. 1998-0324766 discloses a method for manufacturing foamed aliphatic polyester particles and a molded product therefrom by adding a cross-link agent containing such organic peroxides as diacylperoxide (benzoyl peroxide, lauroyl peroxide, stearoyl peroxide, etc.), peroxy dicarbonate (bis<4-t-butylcyclohexyl>peroxy dicarbonate, diisopropyl peroxy dicarbonate) or peroxy ester (t-butyl peroxy isobutylate, etc.) to a non-cross-link aliphatic polyester resin to obtain a cross-linked resin of at least 5 parts by weight % in a gel fraction.

Also, the open Korea Patent Publication No. 2001-0060152 discloses a method for obtaining a molded product based on a cross-linked polyester resin by adding 0.005 to 10 parts by weight of the cross-link agent containing such organic peroxides as alkyl peroxide compounds, peroxyester compounds, diacylperoxide compounds, peroxy ketal compounds, etc. based on 100 parts by weight of polyester in order to increase melt viscosity of aromatic and aliphatic polyesters.

Since the cross-link agent containing the organic peroxide disclosed in the above open Japan Patent Publication No. 1998-0324766 and the open Korea Patent Publication No. 2001-0060152 must be added to general aromatic polyester resin and subject to melt mixing or melt extrusion processes that must be kept at a temperature equal to or higher than approximately 250□ (the melting point of the general aromatic polyester resin) in order to produce foamed products, the organic peroxide contained in the polyester resin is decomposed (at approximately 180□, organic peroxides are decomposed) and it can thus not serve as a cross-link agent, as shown in Graph 1 of the following experiment graph {Changes in Melt Index (MI) depending on Temperature}.

According to the experiment, the melt index of resin in order to produce a foamed product should be about 3 to 7 (preferably 4 to 5). When the MI of resin is equal to or greater than 7, flowability is lowered in the melt extrusion process for foaming, or foaming magnification is lowered due to foaming gas outflow in the foamed cells.

[Graph 1] Changes of Melt Index depending on Temperature

[image]

<The melt indices were measured from a test sample of cross-linked aromatic polyester resin (containing 35 mol % of IPA) with the melt indexer of Gottfert, pursuant to ASTM 1238.>

Generalizing the aforementioned facts, it is possible to apply the organic peroxides to the aliphatic polyester resin with a low melting point, but it is disadvantageous in that cross-linking capability is lowered because the cross-link structure is decomposed in manufacturing a foamed product by applying the organic peroxide to the general aromatic polyester with a high melting point. Accordingly flowability is lowered in the melt extrusion process, or foaming magnification is lowered due to weakened foaming gas collection ability, and thermal resistance, tensile strength and dimensional stability of a foamed product are lowered in addition, resulting in various problems not allowing easy commercialization.

### BRIEF SUMMARY OF THE INVENTION

The present invention was devised to solve the aforementioned problems. It is an object of the invention to provide a method for producing a foamed product in which a cross-link agent is not decomposed and cross-linking ability is also not lowered by producing an aromatic polyester resin whose melting point ranges 80 to 80, and adding the cross-link agent containing organic peroxides to the resultant resin to obtain an aromatic polyester resin with a low melting point and high viscosity then to be subject to melt mixing and melt extrusion at a lower process temperature ranging 80 to 80□.

### BRIEF DESCRIPTION OF THE DRAWINGS

The benefits and advantages of the present invention will become more readily apparent to those of ordinary skill in the relevant art after reviewing the following detailed description and accompanying drawing, wherein:

FIG. 1 shows a process for producing an aromatic polyester foam sheet.

### DETAILED DESCRIPTION OF THE PREFERRED EMBODIMENTS

The present invention related to a method for producing a foamed product based on aromatic polyester resin is characterized in that the foamed product is produced through melt mixing or melt extrusion after first producing an aromatic polyester resin whose melting point ranges 80 to 80□.

For this purpose, the present invention is further characterized in that the processing temperature, that is the melt mixing and melt extrusion temperature, ranges 80 to 80□ for producing a foamed product based on the aromatic polyester resin with a low melting point to which a cross-link agent containing an organic peroxide is added.

The method for producing the aromatic polyester resin for forming whose melting point ranges 80 to 80□ is characterized in that the resin is produced in copolymerization by selecting at least one of isophthalic acid (IPA), adipic acid (AA), succinic acid (SA), diethylene glycol (DEG), triethylene glycol (TEG), polyethylene glycol (PEG) and 1,4-cycloheximethanol (1,4-CHDM), and then by inputting the selected one into the mixture or some reaction products of terephthalic acid (TPA) and ethylene glycol (EG) under polymerization process, or the mixture or some reaction products of dimethylterephthalate (DMT) and ethylene glycol (EG) (the selected one must be input in any course of esterification, interesterification or condensation polymerization at the polymerization step), in the above polymerization step (for polymerizing TPA and EG or DMT and EG) that is a key process for producing the aromatic polyester resin.

Preferably, 17 to 50 parts by weight of the aforementioned IPA, DEG, AA, SA, TEG, PEG or 1,4-CHDM based on 100 parts by weight of the polyester resin are to be input. It is because, if less than or equal to 17 parts by weight are input, the melting point of the aromatic polyester resin becomes equal to or higher than 80□, and, if the parts by weight equal to or greater than 50 parts by weight are input, the melting point of the polyester resin becomes equal to or lower than 80□.

Cross-linking can be achieved by adding the aforementioned organic peroxide cross-link agents to non-cross-link aromatic polyester resins, using such a continuous production apparatus as a melt mixing unit or a melt extruder, or an oven, etc., and then raising the temperature to approximately 80 to 180□.

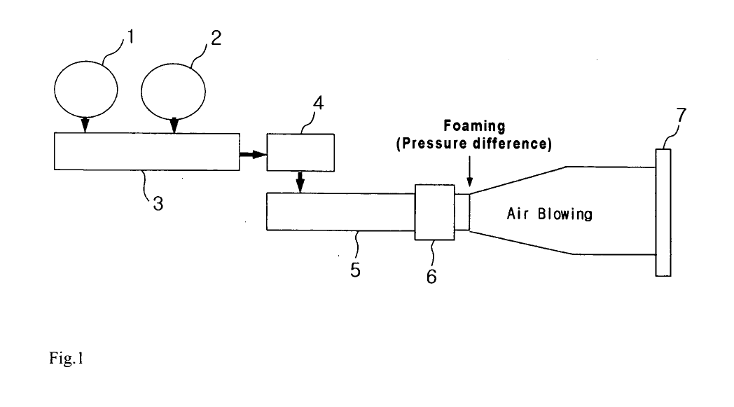

Hereinafter, with reference to FIG. 1, the method for producing a foamed product based on aromatic polyester resin according to the invention will be described in detail. FIG. 1 shows a process and an apparatus for producing a foamed product based on the aromatic polyester resin in a first embodiment according to the invention. After inputting the aromatic polyester resin 1 cross-linked by an organic peroxide cross-link agent into a melt mixing unit 3 and pushing a foaming gas 2 into the unit 3 then to mix them sufficiently, foreign matters are removed by means of a filter 4. The temperature of the mixture is then lowered to a temperature lower than a given temperature through a cooling unit 5. If the mixture is subsequently extruded into the air from the extruder 6, the polyester resin containing foaming gas is foamed and molded in tube shape by a pressure difference and air blowing. The resultant tube-shaped foamed product is then cooled and cut with a knife (not shown) to obtain a foamed aromatic polyester sheet. The foamed polyester sheet as described above is wound in roll shape with a winder 7 (the sheet may be cut in chip shape using a cutter, if required).

As the foaming agent, a chemical foaming agent or a physical agent can be used. The chemical foaming agent that is decomposed and produces gas at a temperature higher than or equal to a softening point of the aromatic polyester resin includes azocarbon amide, dinitroso penta methylene tetramin, hydrazone dicarbon amide, sodium bicarbonate, etc. The physical foaming agent includes such saturated hydrocarbons as propane, n-butane, isobutane, n-pentane, isopentane, cyclopentane and hexane, and such halogenated hydrocarbons as methyl chloride and freon, etc. Furthermore, it is possible to use such inert gases as carbon dioxide, nitrogen, etc. as a foaming agent.

It is another method to obtain an excellent foamed product in characteristics by inputting the cross-linked aromatic polyester resin together with polyester master batch (MB) chips containing a filling material into a melt-mixing unit in the course of the aforementioned foaming process. The filling material may be talc, mica, clay, bantonite, zeolite, calcium carbonate, magnesium oxide, carbon, etc., being used for adjusting air bubbles, improving foaming magnifications, stabilizing foamed cells, etc.

For the present invention, respective and all the physical properties were measured in the manner as described below.

(1) Thermal Resistance

Thermal resistance of the foamed product based on aromatic polyester resin was evaluated pursuant to Japan Industrial Standard (JIS) K6767. That is, the foamed product was input into a constant temperature oven at 140□ and retained for 24 hours. From an absolute value of difference between the dimension of the foamed product before heating and the dimension thereof after heating, the ratio of thermal dimension change (%) was obtained, using the following equation. It was evaluated to be ‘o’ (good thermal resistance) if the ratio of thermal dimension change was equal to or smaller than 2%, and ‘x’ (bad thermal resistance) if the ratio was larger than 2%.
Ratio of thermal dimension change|(%)=dimension before heating−dimension after heating|/dimension before heating*100

(2) Foaming Magnification

The foaming magnification of the cross-linked aromatic polyester resin is calculated by comparing the specific gravity before foaming with that after foaming.
Foaming magnification (times)=specific gravity of a sample before foaming/specific gravity of the sample after foaming

(3) Compression Strength

On the basis of JIS K7220, compression strength was measured in 20% compression at 23□.

(4) Bending Strength

On the basis of JIS K722 1, bending strength was measured at 23□.

(5) Contents of Isophthalic Acid (IPA)

The IPA contents (mol %) shown in Table 1 in which the results of the embodiments are described mean the ratio of the amount of input IPA to the total amount of input terephthalic acid (TPA) and isophthalic acid (IPA) to be input for producing aromatic polyester resin.

Hereinafter, the present invention will be described in detail on the basis of the embodiments and comparative examples.

[Embodiment 1]

First, 100 parts by weight of terephthalic acid (TPA) and 75 parts by weight of ethylene glycol (EG) are input to a reactor for esterification for six hours while heating the mixture from 30□ to 230□ during reaction to produce BHT (Bis-β-Hydroxyethylene Terephthalate). The slurry of 175 parts by weight mixed with 30 parts by weight of TPA, 70 parts by weight of isophthalic acid (IPA), 65 parts by weight of EG and 10 parts by weight of DEG is subsequently input for two hours. The slurry is additionally reacted for one and half hour while keeping the temperature of the mixture at 230□.

Then 175 parts by weight of produced BHT is transferred to a condensation polymerization reactor. When the transferring is completed, 0.02 weight of phosphoric acid based on the polymer is input. Five minutes after finishing input, 0.015 weight of antimonytrioxide based on the polymer is diluted with a small amount of ethylene glycol, and the mixture of antimonytrioxide and ethylene glycol is then input. For 60 minutes, the mixture is pressurized to 1.0 torr and the temperature of the mixture is raised from 230□ to 285□ for 50 minutes at the same time. At this state, condensation polymerization is applied for three hours to produce the polymer the temperature of which reactant is 285□, whose inherent viscosity (IV) is 0.63, and whose melting point is 110□ to obtain aromatic polyester chips with a low melting point by cutting the polymer with a cutter.

After inputting, mixing and cross-linking 100 parts by weight of the obtained polyester chips and 5 parts by weight of dibenzoylperoxide as a cross-link agent into/in a mixer, the cross-linked aromatic polyester resin is produced and then chips are produced after cutting the resin.

The cross-linked aromatic polyester chips with a low melting point are input into a melt mixing unit whose maximum temperature is set to 1300 together with polyester master batch (MB) chips containing talc while pressing liquefied petroleum gas (LPG) as a foaming agent into the melt mixing unit. After filtering and then passing the mixture through a cooling unit as shown in FIG. 1, foamed aromatic polyester sheets with a low melting point are produced by foaming caused by pressure difference between the inside of an extruder and atmospheric pressure.

[Embodiment 2]

After primarily producing pure BHT as in the embodiment 1, 60 parts by weight of TPA, 40 parts by weight of IPA, 65 parts by weight of EG and 10 parts by weight of DEG are input into the pure BHT (subsequent processes are the same as those in the embodiment 1) to produce aromatic polyester chips with a low melting point whose inherent viscosity is 0.63 and whose melting point is 150□. While the maximum temperature in the mixing unit is set to 170□ for the foaming process, the same foaming process as in the embodiment 1 is applied to produce foamed sheets.

### COMPARATIVE EXAMPLE 1

After primarily producing pure BHT as in the embodiment 1, 100 parts by weight of TPA, 65 parts by weight of EG and 10 parts by weight of DEG are input into the pure BHT (subsequent processes are the same as those in the embodiment 1) without input of isophthalic acid, to produce polyester chips whose inherent viscosity is 0.63 and whose melting point is 252□. While the maximum temperature in the mixing unit is set to 280□ for the foaming process, the same foaming process as in the embodiment 1 is applied to produce foamed sheets.

### COMPARATIVE EXAMPLE 2

After primarily making pure BHT as in the embodiment 1, 80 parts by weight of TPA, 20 parts by weight of IPA, 65 parts by weight of EG and 10 parts by weight of DEG are input into the pure BHT to produce polyester chips whose inherent viscosity is 0.63 and whose melting point is 2200 through polymerization with the same process as in the embodiment 1. While the maximum temperature in the mixing unit is set to 240□ for the foaming process, the same production and foaming processes as in the embodiment 1 are applied to produce foamed sheets.

### COMPARATIVE EXAMPLE 3

After producing BHT, 150 parts by weight of IPA, 65 parts by weight of EG and 10 parts by weight of DEG are input without input of TPA to produce copolymerized polyester chips whose inherent viscosity is 0.63 and whose melting point is 70□, through the same process as in the embodiment 1. However, since the discharge process is very bad in producing polyester resin and it is thus impossible to obtain good chips, this comparative example may not be applied in order to produce foamed products.

The results from the embodiments and comparative examples described in the above are shown in Table 1,

TABLE 1

| | Embodiment | Embodiment | Comparative | Comparative | Comparative |
|---|---|---|---|---|---|
| | 1 | 2 | example 1 | example 2 | example 3 |
| IPA contents | 35 | 20 | 0 | 10 | 60 |
| (mol %) | | | | | |
| Melting point | 110 | 150 | 252 | 220 | 70 |
| (□) | | | | | |
| Mixing unit | 130 | 170 | 280 | 240 | — |
| temp. (□) | | | | | |
| Melt index | 3.3 | 5.2 | 65 | 60 | — |
| (g/min) | | | | | |
| Thermal | good | good | Bad | Bad | |
| resistance | | | | | |
| (dimension | | | | | |
| stability) | | | | | |
| Foaming | 25 | 27 | 7 | 6 | — |
| magnification | | | | | |
| (times) | | | | | |
| Bending | 5.0 | 5.5 | 4.5 | 4.0 | — |
| strength (MPa) | | | | | |
| Compression | 4.0 | 4.5 | 3.5 | 3.0 | — |
| strength (MPa) | | | | | |

As described in the above, according to the present invention, it is possible to obtain foamed products based on aromatic polyester resin with a low melting point, excellent in thermal resistance, foaming magnification, strength, etc., by cross-linking aromatic polyester resin whose melting point ranges 80 to 180□ with an organic peroxide cross-link agent and then foaming the resin through a melt mixing unit/extruder in which maximum temperature ranges 80 to 180□.

If the melting point of the polyester resin is equal to or higher than 180□ as in the comparative example 1 or 2, the temperature in the melt mixing unit is conditioned to be equal to or higher than 180□ which is a decomposition temperature of the organic peroxide in melt mixing, cross-linking capability cannot thereby be achieved and physical properties thereof such as thermal resistance, strength, foaming magnification, etc. are thus lowered. When polyester resin whose melting point is equal to or lower than 80□ is produced as in the comparative example 3, it is impossible to produce good polyester chips because many defective products are produced during the discharge process.

From the foregoing description, it will be observed that various modifications and changes can be made without departing from the true sprit and scope of the present invention. It should be understood that the foregoing description is intended to illustrate and not to limit the scope of the invention as defined by the claims.

1. A method for producing a foamed product based on aromatic polyester resin, characterized in that the aromatic polyester resin with a low melting point, ranging 80 to 180□, is input to a mixing unit or an extruder together with foaming gas after being cross-linked with an organic peroxide cross-link agent and subject to a melt mixing or melt extrusion process at a temperature ranging 80 to 180□.

2. The method as claimed in claim 1, characterized in that, in a polymerization step, the aromatic polyester resin with a low melting point is produced in copolymerization by selecting at least one of isophthalic acid (IPA), diethylene glycol (DEG), adipic acid (AA), succinic acid (SA), triethylene glycol (TEG), polyethylene glycol (PEG) and 1,4-cycloheximethanol (1,4-CHDM), and then by inputting the selected one into the mixture or some reaction products of terephthalic acid (TPA) and ethylene glycol (EG), or the mixture or some reaction products of dimethylterephthalate (DMT) and ethylene glycol (EG) under polymerization process.

3. The method as claimed in claim 2, characterized in that said input materials are produced by inputting terephthalic acid (TPA) and ethylene glycol (EG) or dimethylterephthalate (DMT) and ethylene glycol (EG) under polymerization, during any one of esterification, interesterification or condensation polymerization, in order to produce the aromatic polyester resin.

4. The method as claimed in claim 2, characterized in that said input materials are 17 to 50 parts by weight based on 100 parts by weight of the polyester resin.

5. The method as claimed in claim 1, characterized in that the organic peroxide is an alkylperoxide compound, a peroxyester compound, a diacylperoxide compound, and a peroxyketal compound.

6. The method as claimed in claim 1, characterized in that the polyester resin is cross-linked so that the melt index (MI) of the cross-linked aromatic polyester resin is 3 to 7 g/min at a temperature ranging 80 to 180□.

7. The method as claimed in claim 1, characterized in that more than 70% of the structural unit of the aromatic polyester with a low melting point is polyethyleneterephthalate.

8. The method as claimed in claim 1, characterized in that polyester master batch chips mixed with a filling material consisting of inorganic particles are input together when the aromatic polyester with a low melting point is input into a melt mixing unit or a melt extruder.
